(19) United States
(12) Patent Application Publication
(10) Pub. No.: US 2012/0268568 A1
(43) Pub. Date: Oct. 25, 2012

(54) METHOD AND APPARATUS OF REDUCING VISUAL VIBRATION OF A MOBILE ELECTRONIC DISPLAY

(75) Inventors: Xintian Li, Cupertino, CA (US); Xuerui Zhang, San Diego, CA (US)

(73) Assignee: QUALCOMM INNOVATION CENTER, INC., San Diego, CA (US)

(21) Appl. No.: 13/089,448

(22) Filed: Apr. 19, 2011

(51) Int. Cl. H04N 13/02; H04N 5/225

(52) U.S. Cl. 348/47; 348/207.1; 348/E05.024; 348/E13.074

(57) ABSTRACT

A mobile computing device comprising one or more sensors and an electronic display is disclosed herein. The one or more sensors are adapted to determine a distance between the mobile computing device and a mobile computing device user, and are also adapted to determine a position of the mobile computing device relative to the mobile computing device user. The electronic display is adapted to modify visual content on the electronic display relative to a change in at least one of, the distance between the mobile computing device and a mobile computing device user, and the position of the mobile computing device relative to the mobile computing device user.

### FIELD OF THE INVENTION

The present invention relates to mobile computing devices. In particular, but not by way of limitation, the present invention relates to apparatus and methods for reducing the vibration of visual content on mobile computing devices, relative to the mobile computing device user.

### BACKGROUND OF THE INVENTION

Content is often viewed on mobile computing devices when the user of the mobile computing device is traveling in a vehicle. For example, many users of mobile computing devices frequently use the device to view content when they are a passenger in an automobile, airplane, boat, or other vehicle. However, viewing content on a mobile computing device while traveling in a vehicle may be difficult due to the vibration of the mobile computing device, caused by the movement of the vehicle. The vibration of the mobile computing device often causes the size and location of the visual content to change, relative to the mobile computing device user.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

In order to improve the ability to view visual content on mobile computing devices when traveling in vehicles, embodiments of the invention limit the movement of visual content displayed on the mobile computing device relative to the mobile computing device user. One embodiment of the invention may be characterized as a method of changing a display of visual content on a mobile computing device. One method may comprise measuring a distance between the mobile computing device and a location proximal a mobile computing device user's eyes (or another feature proximal the mobile computing device user's face, or placed on the user's face, such as, but not limited to, glasses or another item proximal the user's eyes). The method may further comprise determining a position of the location proximal the mobile computing device user's eyes relative to the mobile computing device. The method then includes changing at least one of (i) the distance between the mobile computing device and the location proximal the mobile computing device user's eyes, and (ii) the position of the mobile computing device relative to the location proximal the mobile computing device user's eyes. A display on the mobile computing device is then changed relative to the change in the at least one of (i) the distance between the mobile computing device and the location proximal the mobile computing device user's eyes, and (ii) the position of the mobile computing device relative to the location proximal the mobile computing device user's eyes.

Another embodiment of the invention comprises a mobile computing device comprising one or more sensors adapted to determine a distance between the mobile computing device and the mobile computing device user. The one or more sensors are further adapted to determine a position of the mobile computing device relative to the mobile computing device user. The mobile computing device further comprises an electronic display adapted to modify the visual content displayed on the electronic display relative to a change in at least one of, (i) the distance between the mobile computing device and the mobile computing device user, and (ii) the position of the mobile computing device user relative to the mobile computing device user.

Yet another embodiment of the invention may be characterized as a mobile computing apparatus. One mobile computing apparatus comprises a means for determining a distance between a mobile computing device and a location proximal a mobile computing device user's face. The mobile computing apparatus may also comprise a means for determining a position of the mobile computing device relative to a location proximal the mobile computing device user's eyes. Furthermore, the apparatus may also comprise a means for changing at least one of (i) the distance between the mobile computing device and the location proximal the mobile computing device user's eyes, and (ii) the position of the mobile computing device relative to the location proximal the mobile computing device user's eyes. Additionally, the mobile computing apparatus may comprise a means for changing a display on the mobile computing device relative to the change in the at least one of (i) the distance between the mobile computing device and the location proximal the mobile computing device user's eyes, and (ii) the position of the mobile computing device relative to the location proximal the mobile computing device user's eyes.

And another embodiment of the invention may be characterized as a non-transitory, tangible computer readable storage medium, encoded with processor readable instructions to perform a method of changing a display of visual content on a mobile computing device electronic display. One method comprises measuring a distance between the mobile computing device and a location proximal a mobile computing device user's eyes. The method may further comprise determining a position of the mobile computing device relative to the location proximal the mobile computing device user's eyes. The method may also comprise changing the display of visual content on the mobile computing device relative to a change in at least one of (i) the distance between the mobile computing device and the location proximal the mobile computing device user's eyes, and (ii) the position of the mobile computing device relative to the location proximal the mobile computing device user's eyes.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, where like or similar elements are designated with identical reference numerals throughout the several views and wherein:

FIG. 1 illustrates a block diagram depicting physical components of an exemplary embodiment of the present invention;

FIG. 2 illustrates an isometric view of a mobile computing device and a user of a mobile computing device in accordance with one exemplary embodiment of the invention;

FIGS. 3A-3C illustrates a top view of a mobile computing device and a user of a mobile computing device in accordance with one exemplary embodiment of the invention;

FIGS. 4A-4B illustrates movement of visual content on the mobile computing device in accordance with one exemplary embodiment of the invention;

FIGS. 5A-5B illustrates movement of visual content on the mobile computing device in accordance with one exemplary embodiment of the invention; and

FIG. 6 illustrates a flowchart that depicts a method that may be carried out in connection with the embodiments described herein.

### DETAILED DESCRIPTION

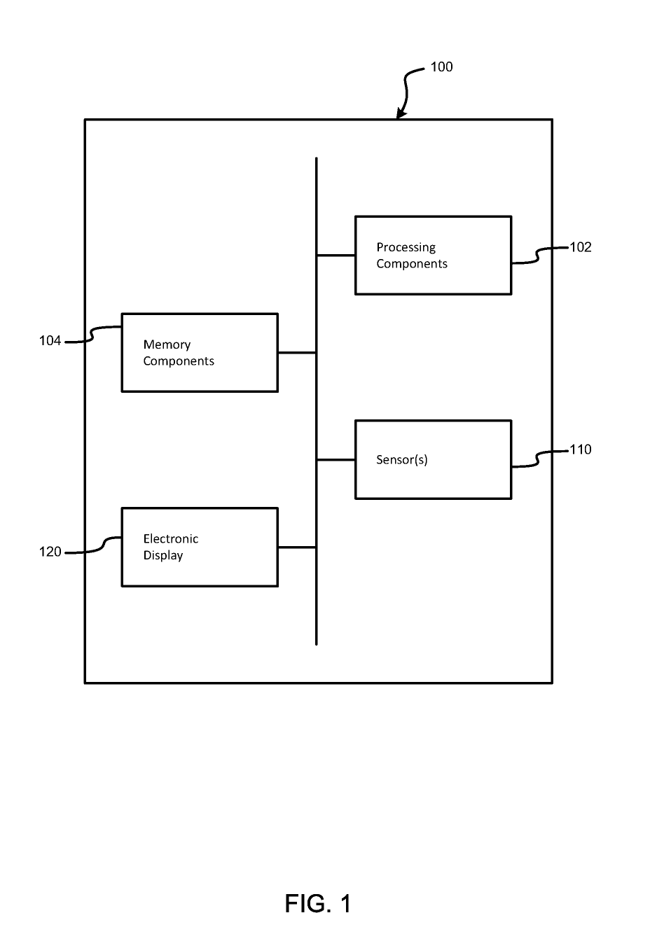

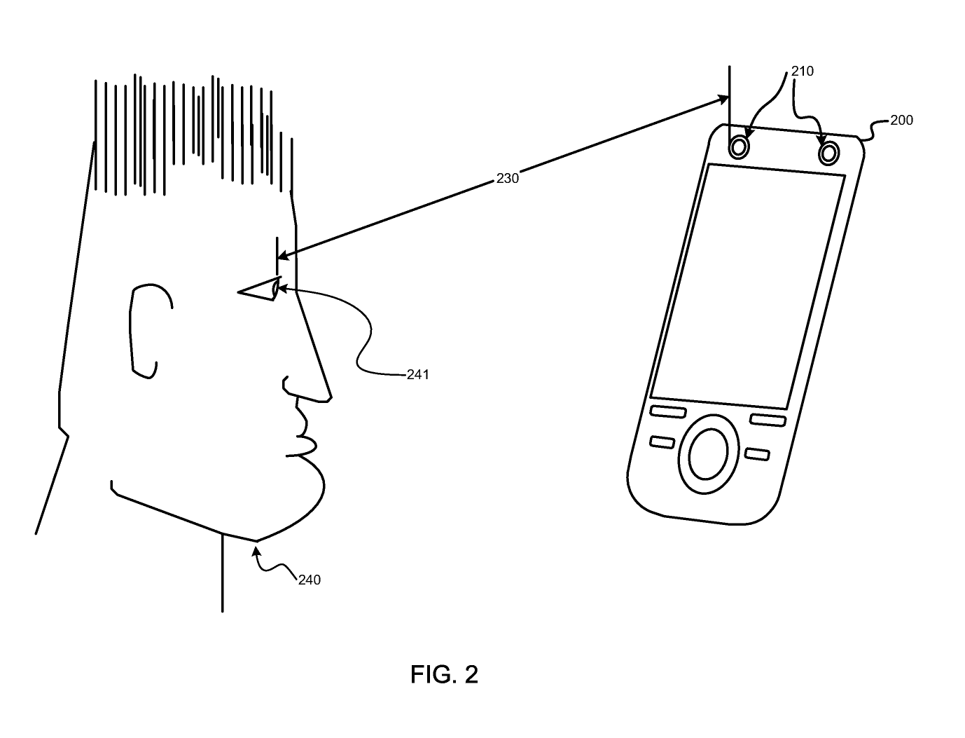

Referring first to FIG. 1, shown is a block diagram depicting physical components of a mobile computing device 100. One mobile computing device 100 comprises one or more sensors 110 and an electronic display 120. The one or more sensors 110 are adapted to determine a distance between the mobile computing device 100 and a mobile computing device user. For example, seen in FIG. 2 is one distance 230 between the mobile computing device 200 and a mobile computing device user 240. The one or more sensors 210 are also adapted to determine a position of the mobile computing device user 240 relative to the mobile computing device 200.

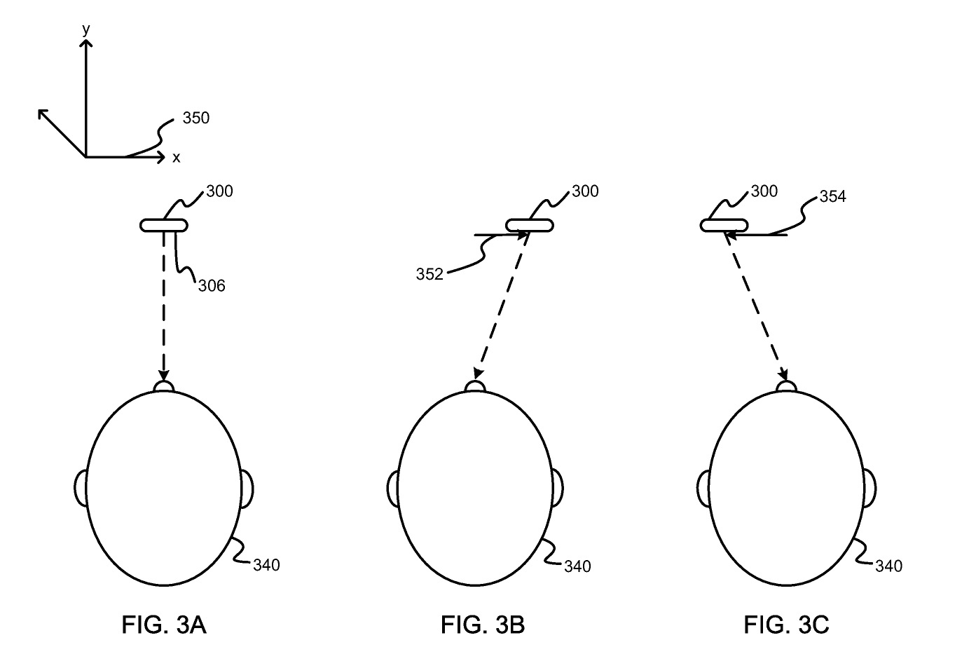

Seen in FIG. 3A is a mobile computing device 300 and a mobile computing device user 340 with the mobile computing device 300 in a first position relative to the mobile computing device user 340. One first position comprises a mobile computing device front side 306 substantially directly opposing a mobile computing device user's face. Seen in FIG. 3B is a mobile computing device 300 in a second position relative to the mobile computing device user 340. In one embodiment, the second position comprises a location along a first axis 350 relative to the mobile computing device user 340. For example, the second position may be located a first direction 352 along the first axis 350. In FIG. 3B, the first direction 352 of the first axis 350 comprises a substantially horizontal direction to the right of the mobile computing device user 340. Seen in FIG. 3C is a mobile computing device 300 in a third position relative to the mobile computing device user 340. In one embodiment, the third position of the mobile computing device 300 is along a second direction 354 on the first axis 350, wherein the second direction 354 is to the left of the mobile computing device user 340. Other positions, including various vertical positions, are also contemplated.

Returning to FIG. 1, in one embodiment, the one or more sensors 110 comprise one or more 3D cameras, or, camera sensors. For example, as seen in FIG. 2, the one or more sensors 210 comprise a pair of 3D camera sensors. The 3D camera sensors may be adapted to locate at least one of (i) the eyes 241 of a mobile computing device user 240, (ii) glasses being worn by the mobile computing device user 240, such as, but not limited to, 3D glasses, and/or (iii) one or more markers located proximal at least one of the mobile computing device user 240 and the glasses. One marker may be a sticker placed on the glasses. However, other native markers are contemplated such as, but not limited to, an earlobe. It is contemplated that although terms such as, but not limited to, face, eyes 241, glasses, markers, etc., may be used to describe a feature on the mobile computing device user 240, such use is not intended to limit this description to that particular feature and any and all similar features known in the art are contemplated, where appropriate. Furthermore, it is contemplated that an algorithm may be used to determine eye movements of a mobile computing device user 240 that are caused by a vehicle vibration. In such an embodiment the actual distance 230 and mobile computing device 200 position in FIGS. 2-3C may not be used and the calculated distance 230 and position may be used instead.

The mobile computing device 100 also comprises an electronic display 120. The visual content displayed on the electronic display 120 is adapted to be modified relative to a change in at least one of, the FIG. 2 distance 230 between the mobile computing device 200 and the mobile computing device user 240, and the position of the mobile computing device 300 relative to the mobile computing device user 340, such as, but not limited to, changing from one of the first, second, and third position in FIGS. 3A-3C to any other of the first, second, and third position in FIGS. 3A-3C.

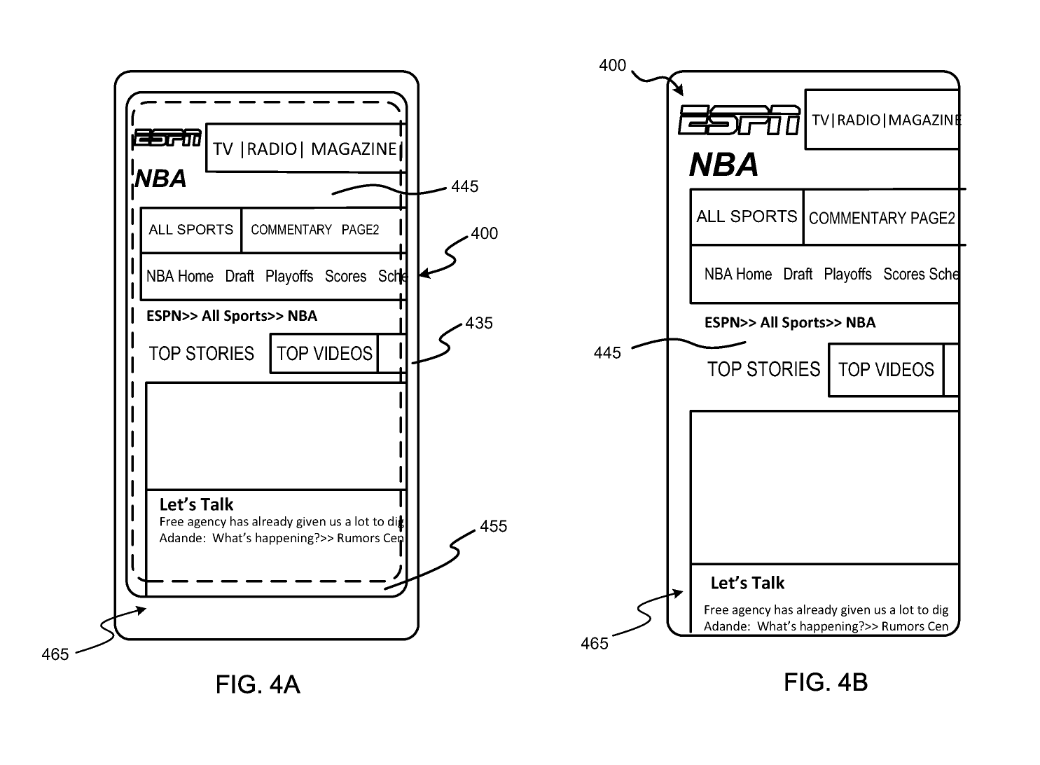

It is contemplated that in one embodiment, a change in the in the distance 230 between the mobile computing device 200 and the mobile computing device user 240 may comprise an increase in the distance 230 due to the vibrations caused by traveling in a vehicle. In such an instance, the visual content displayed on the electronic display 120 may be modified by zooming towards the visual content. For example, seen in FIG. 4A is one display of visual content 445 prior to the distance 230 between the mobile computing device 200 and the mobile computing device user 240 increasing. As seen, in one embodiment, there may be a border 435 between the visual content 445 and the edge of the mobile computing device 400. The border 435 may be adapted to allow the display of the visual content 445 to be increased. For example, the border 435 may allow at least one of the font size and picture size displayed in the visual content 445, to increase. Seen in FIG. 4B is an increased visual content size, removing the border 435, but not removing any visual content 445. Other embodiments are contemplated where no border 435 is used. In such an embodiment, zooming into the visual content 445 may remove an edge portion 455 of the visual content 445 seen in FIG. 4A between the dashed line and the edge of the visual content 445.

In one embodiment, the change of the display of the visual content 445 is adapted to minimize the effect of the change in the distance 230 between the mobile computing device 200 and the mobile computing device user 240, caused by the vehicle movement. For example, by increasing the at least one of the font size and picture size as the distance 230 is increased, the visual content 445 may appear the same size to the mobile computing device user 240. In a similar fashion, font size and picture size may be decreased when the distance 230 is decreased.

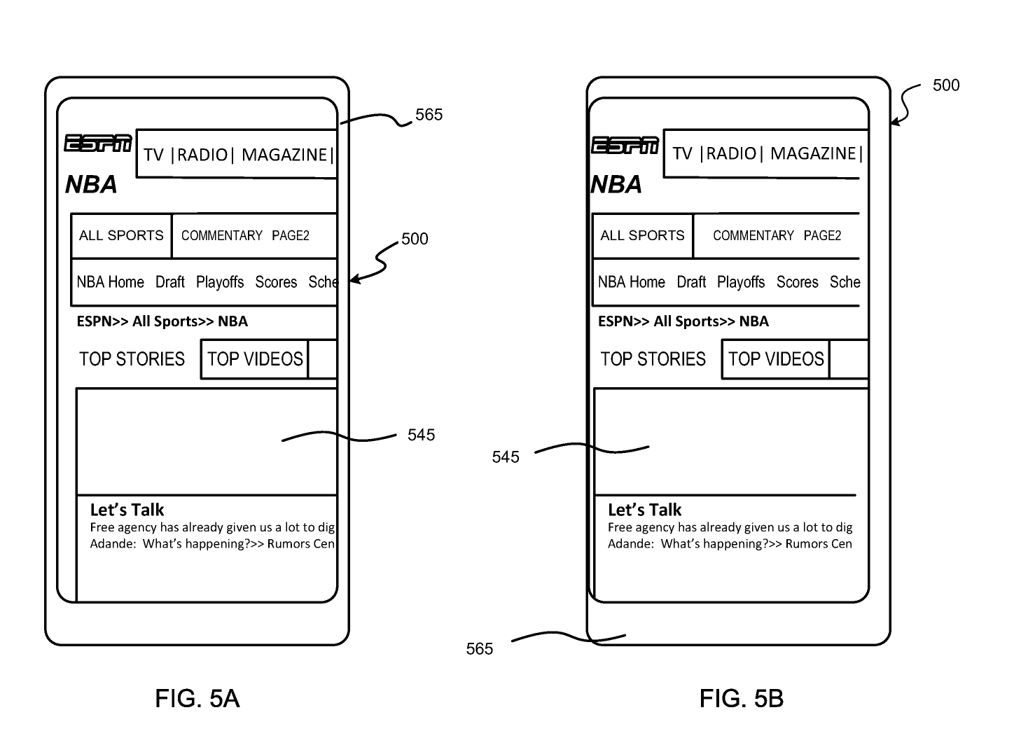

Visual content 445 may also be adjusted on the mobile computing device electronic display 465 when the mobile computing device 400 moves in a horizontal and/or a vertical direction. As seen in FIGS. 3A, 3B, 5A and 5B, when the mobile computing device 300 moves in the first direction 352 from the first position seen in FIG. 3A to the second position seen in FIG. 3B, the mobile computing device 500 may be adapted to move the visual content on the electronic display 565 in the second direction 354, where the second direction may substantially oppose the first direction. In one embodiment, the first direction 352 may comprise a direction substantially to the right and the second direction 354 may comprise a direction substantially to the left, relative to the user 340. In moving the visual content 545 in a direction opposing the movement of the mobile computing device 500, the movement of the visual content 545 may appear diminished to the mobile computing device user 240. For example, the visual content 545 on the mobile computing device 500 may slide from the position seen in FIG. 5A to the position seen in FIG. 5B. In one embodiment, when the mobile computing device 300 moves a first distance from the first position of FIG. 3A to the second position of FIG. 3B, the visual content 545 moves less than the first distance. For example, the visual content 545 may only be able to slide in a direction opposing the first direction 352 on the electronic display a second distance. A similar movement of the visual content 545 opposing the movement of the mobile computing device 500 occurs when moving the mobile computing device moves in other horizontal and vertical directions, such as, but not limited to, from the first position to the third position.

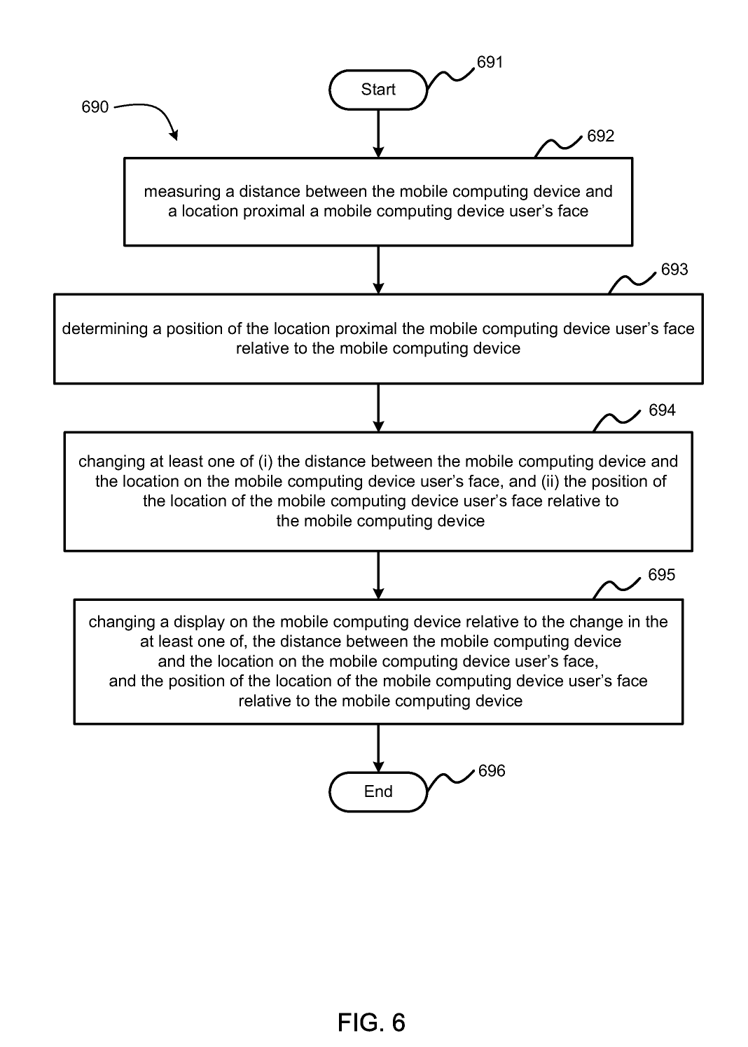

Turning now to FIG. 6, seen is a method 690 of changing a display of visual content on a mobile computing device 100. The method starts at 691 and at 692 comprises measuring a distance between the mobile computing device 100 and a location proximal a mobile computing device user's eyes/face. One or both eyes may be used. In one embodiment, the distance comprises the distance 230 seen in FIG. 2. Furthermore, one location proximal the mobile computing device user's eyes may comprise a mobile computing device user's eyes 241 themselves. The distance 230 may be measured with the one or more sensors 210 seen in FIG. 2, which may comprise 3D camera sensors. In one embodiment, a non-transitory, tangible computer readable storage medium, encoded with processor readable instructions, and located on the mobile computing device 100 may perform the method 690. The non-transitory, tangible computer readable storage medium may be a portion of, or located in, mobile computing device memory components 104.

At 693 one method 690 comprises determining a position of the mobile computing device 100 relative to the location proximal the mobile computing device user's eyes 241. For example, as seen in FIGS. 2-3C, and as discussed above, the sensors 210 may determine that the mobile computing device 300 is in a first position, a second position, or a third position, relative to the mobile computing device user 340. Once a position of the mobile computing device 100 with respect to the location proximal the mobile computing device user's eyes 241 is determined, at 694 the method 690 comprises changing at least one of the distance 230 between the mobile computing device 200 and the location proximal the mobile computing device user's eyes 241, and the position of the mobile computing device 200 relative to the location proximal the mobile computing device user's eyes 241. As disclosed above the distance 230 may one of increase and decrease. Furthermore, as disclosed with reference to FIGS. 3A-3C above, the mobile computing device 300 may move from the first position, seen in FIG. 3A, along a first direction 352 of a first axis 350 to the second position of FIG. 3B. Other horizontal and vertical movement is also contemplated.

At 695, the method comprises changing a display on the mobile computing device 100 relative to the change in the at least one of, the distance 230 between the mobile computing device 200 and the location proximal the mobile computing device user's eyes 241, and the position of the mobile computing device 200 relative to the location proximal the mobile computing device user's eyes 241. For example, as disclosed above, if the distance 230 increases, the electronic display 465 of FIGS. 4A and 4B may display an increased font size and/or picture size of the visual content 445. Therefore, the mobile computing device 400 may zoom into the visual content 445 displayed on the mobile computing device 400 in response to the distance 230 between the mobile computing device 200 and the location proximal the mobile computing device user's eyes 241 increasing. Likewise, the mobile computing device 200 may zoom out from the visual content 445 in response to the distance 230 decreasing. Additionally, if the mobile computing device 300 moves along the first axis 350 the first direction 352, the display of visual content 445 on the electronic display 465 may move along the first axis 350 in an opposing second direction 354. In one embodiment, the distance that the mobile computing device 300 moves along the first axis 350 in the first direction 352 comprises a first distance and the distance that the visual content 445 moves along the first axis 350 in the second direction 354 comprises a second distance (that may be less than the first distance) as the size of the screen on the mobile computing device 300 may be smaller than the distance the mobile computing device 300 traveled. It is to be appreciated that the first position, second position, third position, as well as the first direction 352 and second direction 354 may also comprise a vertical component. The method ends at 696.

The change in the display of the visual content 445 seen in FIGS. 4A and 4B and the change in the display of the visual content 545 seen in FIGS. 5A and 5B may be calibrated relative to the change in the at least one of, the distance 230 between the mobile computing device 200 and the location on the mobile computing device user's eyes 241, and the position of the mobile computing device 300 relative to the location of the mobile computing device user's eyes 241. For example, processing components 102 may receive information from the one or more sensors 110 and may determine that the mobile computing device 200 has moved a distance 230 of six inches away from the location proximal the mobile computing device user's eyes 241. Such a change in the distance 230 may be calibrated to a corresponding 1.2x zoom of the visual content 445. Other calibrations are also contemplated for the same or other movements. Calibrations may be set by either the user or by the mobile computing device 200. Similar calibration of mobile computing device 100 movement to visual content movement may be established for correlating the change in position seen in FIGS. 3A-3C to the change in the display of visual content seen in FIGS. 4A-5B.

In conclusion, embodiments of the present invention change the display of a mobile computing device relative to a position of a mobile computing device user to reduce movement of the visual content. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A mobile computing device comprising,
one or more sensors adapted to determine,
a distance between the mobile computing device and a mobile computing device user, and
a position of the mobile computing device relative to the mobile computing device user; and
an electronic display adapted to modify visual content displayed on the electronic display relative to a change in at least one of,
the distance between the mobile computing device and the mobile computing device user, and
the position of the mobile computing device relative to the mobile computing device user.

2. The mobile computing device of claim 1 wherein, the one or more sensors comprise one or more cameras.

3. The mobile computing device of claim 2 wherein the one or more cameras comprise one or more 3D cameras adapted to locate at least one of,
a mobile computing device user's eyes;
glasses being worn by the mobile computing device user; and
one or more markers located proximal at least one of,
the mobile computing device user's eyes, and
the glasses.

4. The mobile computing device of claim 1 wherein,
the change in the distance between the mobile computing device and the mobile computing device user comprises an increase in the distance between the mobile computing device and the mobile computing device user; and
the visual content displayed on the electronic display is modified by zooming towards the visual content.

5. The mobile computing device of claim 4 wherein, zooming towards the visual content comprises increasing at least one of a font size and a picture size.

6. A method of changing a display of visual content on a mobile computing device comprising,
measuring a distance between the mobile computing device and a location proximal a mobile computing device user's eyes;
determining a position of the mobile computing device relative to the location proximal the mobile computing device user's eyes;
changing at least one of,
the distance between the mobile computing device and the location proximal the mobile computing device user's eyes, and
the position of the mobile computing device relative to the location proximal the mobile computing device user's eyes; and
changing the display of visual content on the mobile computing device relative to the change in at least one of,
the distance between the mobile computing device and the location proximal the mobile computing device user's eyes, and
the position of the mobile computing device relative to the location proximal the mobile computing device user's eyes.

7. The method of claim 6 wherein, measuring a distance between the mobile computing device and a location proximal a mobile computing device user's eyes comprises,
using one or more sensors to determine the distance between the mobile computing device and at least one of,
a mobile computing device user's eyes,
glasses being worn by the mobile computing device user, and
a marker on at least one of,
the mobile computing device user's eyes, and
the glasses.

8. The method of claim 7 wherein, the one or more mobile computing device sensors comprise one or more 3D camera sensors.

9. The method of claim 6 further comprising,
calibrating the change in the display on the mobile computing device relative to the change in at least one of,
the distance between the mobile computing device and the location on the mobile computing device user's eyes, and
the position of the location of the mobile computing device user's eyes relative to the mobile computing device.

10. The method of claim 6 wherein,
the display comprises,
text, and
pictures; and
changing a display on the mobile computing device comprises changing at least one of,
the size of one of,
the text, and
the pictures, and
the location of the text and the pictures.

11. A non-transitory, tangible computer readable storage medium, encoded with processor readable instructions to perform a method of changing a display of visual content on a mobile computing device electronic display comprising,
measuring a distance between the mobile computing device and a location proximal a mobile computing device user's eyes;
determining a position of the mobile computing device relative to the location proximal the mobile computing device user's eyes; and
changing the display of visual content on the mobile computing device relative to a change in at least one of,
the distance between the mobile computing device and the location proximal the mobile computing device user's eyes, and
the position of the mobile computing device relative to the location proximal the mobile computing device user's eyes.

12. The non-transitory, tangible computer readable storage medium of claim 11 wherein, changing the display of visual content on the mobile computing device comprises one of,
zooming into the visual content in response to the distance between the mobile computing device and the location proximal the mobile computing device user's eyes increasing; and
zooming out from the visual content in response to the distance between the mobile computing device and the location proximal the mobile computing device user's eyes decreasing.

13. The non-transitory, tangible computer readable storage medium of claim 11, wherein,
a change in the at least one of, the distance between the mobile computing device and the location proximal the mobile computing device user's eyes, and the position of the mobile computing device relative to the location proximal the mobile computing device user's eyes comprises, changing the position of the mobile computing device relative to the location proximal the mobile computing device user's eyes along a first axis in a first direction; and
changing the display of visual content on the mobile computing device comprises, moving the visual content along the first axis in a second direction on the electronic display, the second direction opposing the first direction.

14. The non-transitory, tangible computer readable storage medium of claim 13 wherein, changing the position of the mobile computing device relative to the location proximal the mobile computing device user's eyes along a first axis in a first direction comprises, changing the position of the mobile computing device relative to the location proximal the mobile computing device user's eyes a first distance; and
changing the display of visual content on the mobile computing device comprises, moving the visual content along the first axis a second distance, the second distance being less than the first distance.

15. The non-transitory, tangible computer readable storage medium of claim 14 wherein, moving the visual content along the first axis a second distance comprises removing a section of a visual content border.

16. A mobile computing apparatus comprising,
means for determining a distance between a mobile computing device and a location proximal a mobile computing device user's eyes;
means for determining a position of the mobile computing device relative to the location proximal the mobile computing device user's eyes;
means for changing at least one of,
the distance between the mobile computing device and the location proximal the mobile computing device user's eyes, and
the position of the mobile computing device relative to the location proximal the mobile computing device user's eyes; and
means for changing a display on the mobile computing device relative to changing at least one of,
the distance between the mobile computing device and the location on the mobile computing device user's eyes, and
the position of the mobile computing device relative to the location of the mobile computing device user's eyes.

17. The mobile computing apparatus of claim 16 wherein, the means for determining a distance between a mobile computing device and a location proximal a mobile computing device user's eyes and the means for determining a position of the mobile computing device relative to the location proximal the mobile computing device user's eyes comprises a pair of 3-D cameras.

18. The mobile computing apparatus of claim 16 wherein, means for changing at least one of, the distance between the mobile computing device and the location proximal the mobile computing device user's eyes, and the position of the mobile computing device relative to the location proximal the mobile computing device user's eyes comprises, moving the mobile computing device a first distance along a first direction of a first axis.

19. The mobile computing device of claim 18 wherein, the means for changing a display on the mobile computing device relative to the change in the at least one of, the distance between the mobile computing device and the location on the mobile computing device user's eyes, and the position of the mobile computing device relative to the location of the mobile computing device user's eyes comprises, moving the display on the mobile computing device a second distance along a second direction of the first axis, wherein the second distance is less than the first distance.

20. The mobile computing device of claim 19 wherein, moving the display on the mobile computing device a second distance along a second direction of the first axis comprises removing a section of a visual content border.
